(19) United States
(12) Patent Application Publication
(10) Pub. No.: US 2011/0094478 A1
(43) Pub. Date: Apr. 28, 2011

(54) Fuel injector

(76) Inventors: Martin Scheffel, Vaihingen (DE); Chritina Gerescher, Berlinerstr (DE)

(21) Appl. No.: 11/793,324

(22) PCT Filed: Oct. 7, 2005
(86) PCT No.: PCT/EP05/55094

§ 371 Date: Mar. 18, 2009

(30) Foreign Application Priority Data
Dec. 17, 2004 (DE) 102004060983.7

(51) Int. Cl. F02M 61/14

(52) U.S. Cl. 123/470

(57) ABSTRACT

A receiving borehole of a cylinder head for the mounting of a fuel injector in the cylinder head has a first shoulder area. The counterpart to the first shoulder area of the receiving borehole is a downstream second shoulder area of the valve housing, which is formed so as to result in a form-fitting contact between the shoulder area of the receiving borehole in the cylinder head and the downstream shoulder area of the valve housing. The shoulder areas define a bearing surface, which constitutes a quadric surface in three-dimensional space.

### FIELD OF THE INVENTION

The present invention relates to a fuel injector having a bearing face on a shoulder area in a receiving borehole in the cylinder head

### BACKGROUND INFORMATION

A compensating element as support for a fuel injector in a cylinder head is described in German Published Patent Application No. 103 38 715; it has an annular design and is positioned between a valve housing of the fuel injector and a wall of a receiving borehole of the cylinder head. Furthermore, the compensating element has at least two side pieces, which are braced on the fuel injector and the cylinder head.

A disadvantage is that an additional component must be installed during the final mounting of the fuel injector in the cylinder head. High axial forces acting on the installed fuel injector, and thus on the compensating element, may cause an indentation by pressing the compensating element into the wall of the receiving borehole in the cylinder head. Such an indentation left by the compensating element makes it more difficult to compensate for tolerances when a new fuel injector is mounted in the receiving borehole of the cylinder head inasmuch as a shoulder of a valve housing can get stuck in the indentation.

A particular disadvantage of the device described in the aforementioned publication is the lack of a compact design because an additional component is installed, which may interfere with the functionality of the tolerance compensation, and also causes additional cost by the installation.

### SUMMARY

According to example embodiments of the present invention, the bearing face between a downstream shoulder area of a valve housing and a shoulder area of a receiving borehole of a cylinder head is designed such that an exchanged fuel injector whose valve housing has a downstream shoulder area that is resting in form-fitting manner against the geometry of the shoulder area of the receiving borehole in the cylinder head is readily installable in the receiving borehole in the cylinder head. The newly installed fuel injector in the receiving borehole of the cylinder head may be rotated for tolerance compensation without the newly installed fuel injector leaving an indentation on the shoulder area of the receiving borehole in the cylinder head as a result of tilting.

Furthermore, the add-on parts of support ring and brace plate may be dispensed with, provided the shoulder area of the receiving borehole of the cylinder head in the region of the bearing surface, and the downstream shoulder area of the valve housing are designed as described below. The concave or the convex opposite area to the shoulder area of the receiving borehole of the cylinder head must be reproduced in the valve housing. This yields the advantage that the fuel injector is able to be rotated for tolerance compensation without the valve housing getting stuck at the shoulder area of the receiving borehole.

An additional advantage is that the number of required sealing spots between fuel injector and rail cup is reduced to one sealing spot on the intake side.

Exemplary embodiments of the present invention are depicted in simplified form in the drawing and explained in greater detail in the description below.

### BRIEF DESCRIPTION OF THE DRAWINGS

FIG. 1 is a schematic overall view of a fuel injector, which is installed in a cylinder head of an internal combustion engine together with a conventional compensating element.

FIG. 2 is a schematic part-sectional view of a a fuel injector according to an example embodiment of the present invention, which is installed in a cylinder head.

FIG. 3 is a schematic part-sectional view of a fuel injector according to an example embodiment of the present invention, which is installed in a cylinder head.

FIG. 4 is an exemplary illustration of the deformation, caused by bearing loads, of the supporting shoulder area in a receiving borehole of a cylinder head.

FIG. 5 is a schematic part-sectional view of a fuel injector according to an example embodiment of the present invention, which is installed in a cylinder head.

FIG. 6 is an exemplary illustration of the deformation of the supporting shoulder area in a receiving borehole of the cylinder head, the deformation being caused by bearing loads of a fuel injector such as that illustrated in FIG. 5.

### DETAILED DESCRIPTION

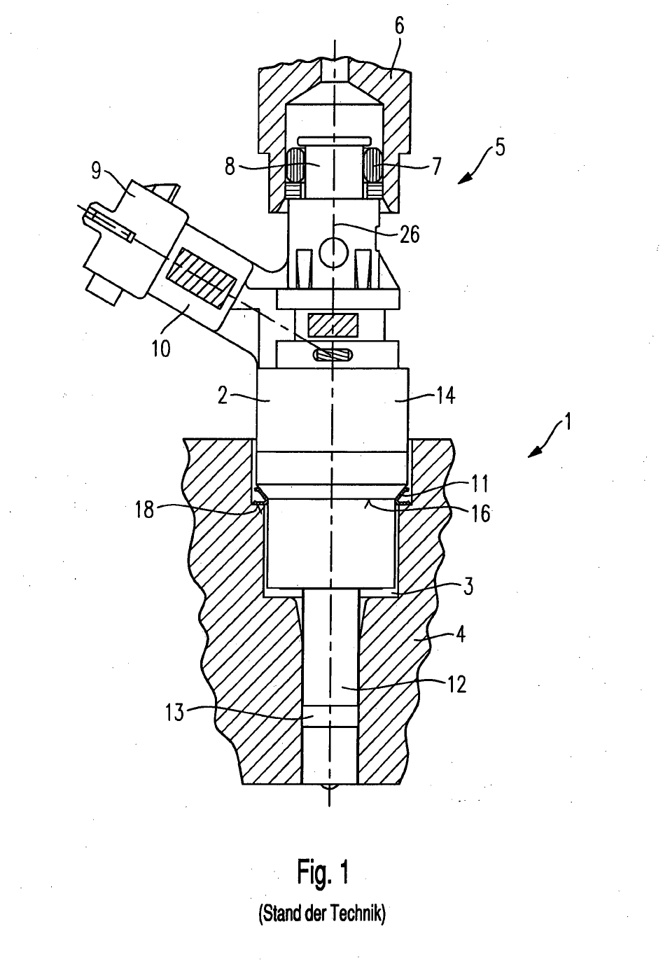

FIG. 1 shows a schematized and simplified representation of a fuel-injection system 1, which includes a fuel injector 2 introduced in a receiving borehole 3 of a cylinder head 4 of an internal combustion engine.

In the case at hand, a fuel injector 2 is designed as a directly injecting fuel injector 2, which may be used for the direct injection of fuel into a combustion chamber of the mixture-compressing internal combustion engine having external ignition. At an end 5 on the intake side, fuel injector 2 is provided with a plug connection to a fuel-distributor line 6, which is sealed by a seal 7 between fuel-distributor line 6 and a supply connection 8 of fuel injector 2. Fuel injector 2 has an electrical connection 9 for the electrical contacting for the purpose of actuating fuel injector 2. At least in the section that projects beyond cylinder head 4, fuel injector 2 is provided with a plastic extrusion coat 10, which also encloses electrical connection 9.

Fuel injector 2 is held in place in cylinder head 4 and protected against twisting by measures such as a clamping shoe. An annular compensating element 11 is provided in receiving borehole 3 to center and support fuel injector 2. Instead of annular compensating element 11, it is also possible to install a brace plate as add-on component. Compensating element 11 has an approximately v-shaped cross-section and ensures reliable tolerance compensation of fuel injector 2 in all degrees of freedom.

A seal 13 made of Teflon®, for instance, is provided on a nozzle body 12 of fuel injector 2, the seal sealing fuel injector 2 from cylinder head 4 of the internal combustion engine.

Fuel injectors 2 are usually rigidly mounted in cylinder head 4 of internal combustion engines and fixed in place as well as guided by an intermediate sleeve that connects fuel injector 2 to fuel-distributor line 6. This makes it possible to compensate for lateral offsets of fuel injector 2. However, if fuel injector 2 is to be installed without an intermediate sleeve, the tolerances must be compensated in some other manner. In addition, it is not enough to compensate only for lateral offsets or tilting. Thermal changes during operation of the internal combustion engine must be taken into account as well. Furthermore, an exchanged fuel injector 2 newly mounted in receiving borehole 3 of cylinder head 4 should not leave any depressions 31 (FIG. 4) in bearing surface 24, i.e., in shoulder area 18 of receiving borehole 3 in cylinder head 4.

The aforementioned requirements are satisfied by shoulder areas 18, 16, configured as described herein, of receiving borehole 3 in cylinder head 4, and by the design of downstream shoulder area 16 of a valve housing 14 as described herein.

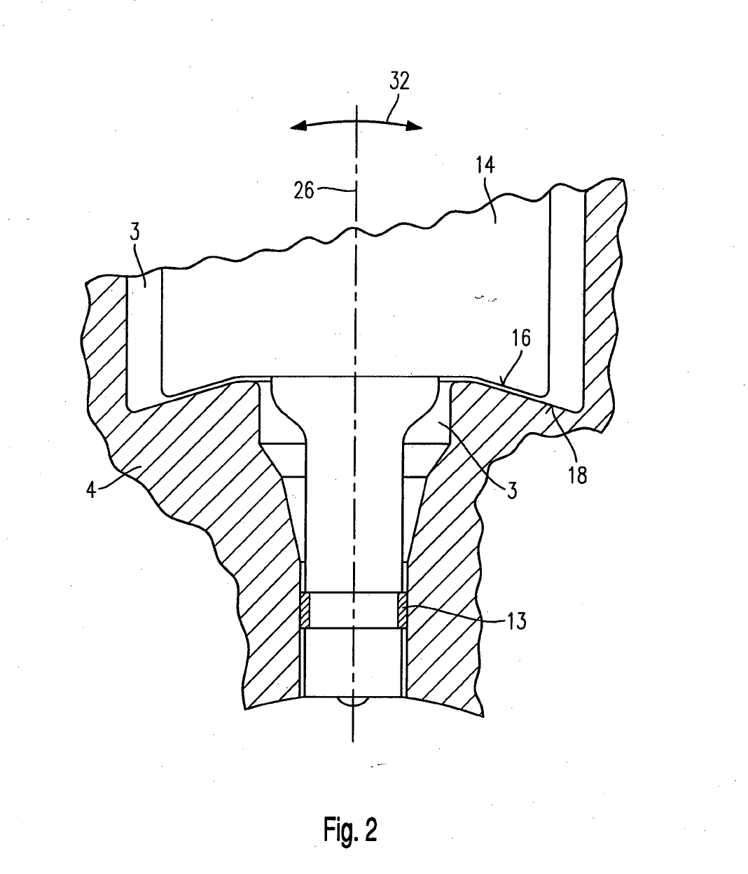

As an exemplary embodiment of the present invention, FIG. 2 shows a fuel injector 2 mounted in a receiving borehole 3 of a cylinder head 4, including a shoulder area 18 of receiving borehole 3 and including a downstream shoulder area 16 of valve housing 14.

Both areas are quadric surfaces in three-dimensional space and deviate from a planar form; downstream shoulder area 16 of valve housing 14 is constructed so as to form the concave or convex counterpart of contacting shoulder area 18 of receiving borehole 3 in cylinder head 4. Valve housing 14 may be rotated relative to longitudinal axis 26, which causes a tolerance compensation 32 to take place and unnecessary stresses in the material due to transversal forces to be reduced.

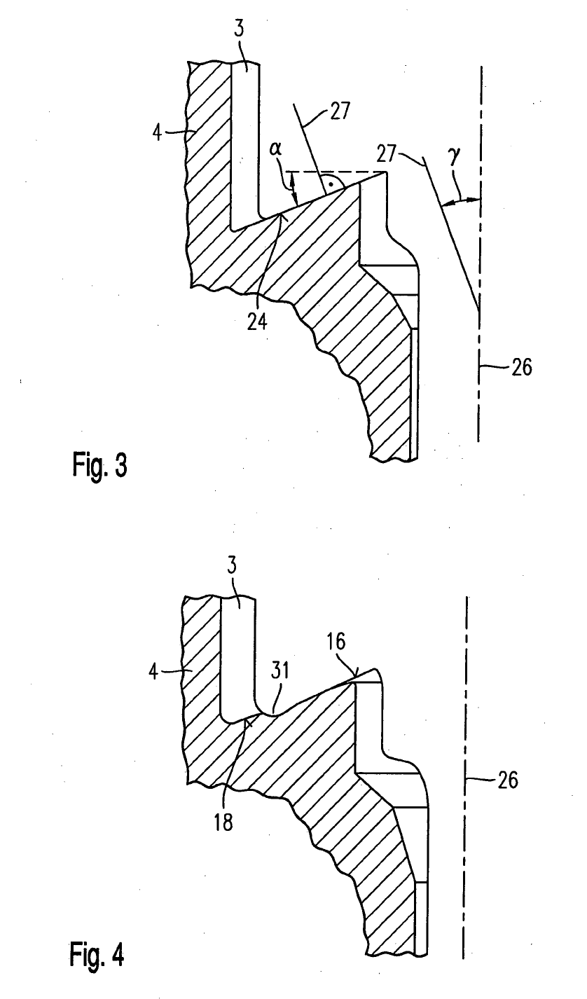

FIG. 3 shows the definition of a slope angle α of downstream shoulder area 16 of valve housing 14 relative to longitudinal axis 26 of fuel injector 2; in this exemplary embodiment bearing surface 24, downstream shoulder area 16 of valve housing 14, and shoulder area 18 of receiving borehole 3 of cylinder head 4 are planar surfaces, and a normal vector 27 of bearing surface 24 is not oriented parallel to longitudinal axis 26 of fuel injector 2; in addition, slope angle α of bearing surface 24 coinciding with downstream shoulder area 16 results with respect to longitudinal axis 26 of fuel injector 2. Furthermore, a slope angle γ that is smaller than 45° comes about between normal vector 27 and longitudinal axis 26 of fuel injector 2.

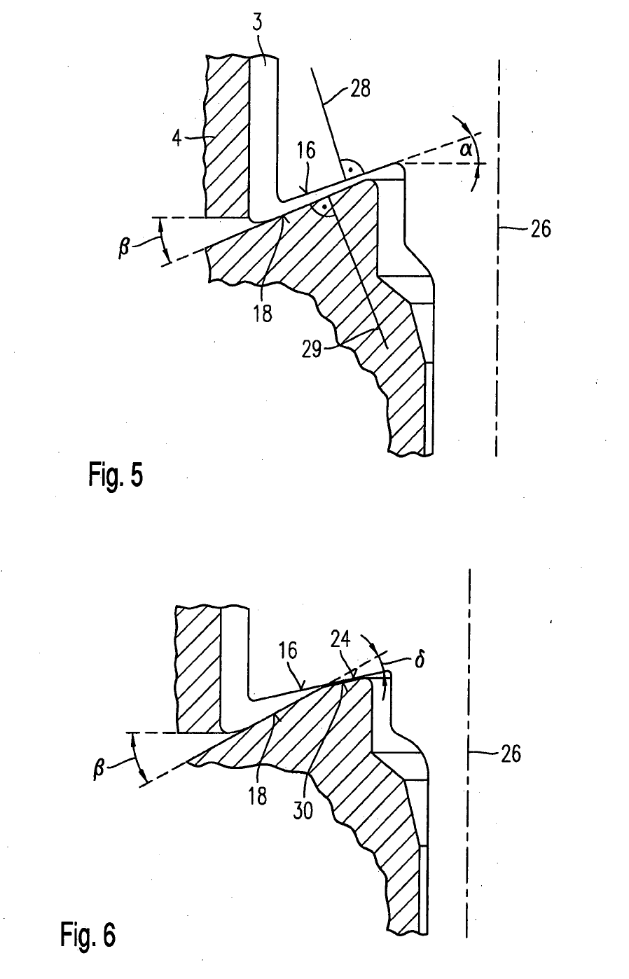

FIG. 4 shows a depression 31 in shoulder area 18 of receiving borehole 3 in cylinder head 4, which may occur if, due to tolerances in the production, slope angle α of downstream shoulder area 16 of valve housing 14 relative to a longitudinal axis 26 of fuel injector 2 is slightly larger than a slope angle β of shoulder area 18 of receiving borehole 3 in cylinder head 4. If a depression 31 has formed in shoulder area 18 of receiving borehole 3 in cylinder head 4, it may happen that an exchanged fuel injector 2 gets stuck in the depression and thus is no longer able to be rotated. This may be counteracted by selecting a slope angle α of downstream shoulder area 18 of valve housing 14 relative to longitudinal axis 26 of fuel injector 2 that is smaller than slope angle β of shoulder area 18 of receiving borehole 3 relative to longitudinal axis 26 of fuel injector 2. This is illustrated in FIG. 5.

FIG. 5 shows that a normal vector 28 of downstream shoulder area 16 of valve housing 14 and a normal vector 29 of shoulder area 18 of receiving borehole 3 of cylinder head 4 are not oriented in parallel with respect to one another.

FIG. 6 illustrates that bearing surface 24 is a partial surface 30 of shoulder area 18 of receiving borehole 3 in cylinder head 4, partial surface 30 being inclined at a third slope angle δ relative to shoulder area 18 of receiving borehole 3.

If plastic deformation occurs at cylinder head 4 due to the high axial forces acting on fuel injector 2 from above as a result of the pressure in the fuel distributor line, this will not cause a depression 31 in shoulder area 18 of receiving borehole 3 where a fuel injector 2 having a different position tolerance may get stuck, since a bearing surface 24 forms on shoulder area 18 of receiving borehole 3 in cylinder head 4 due to the action of a holding-down force acting from above and the action of a bracing force acting from below, the bearing surface having a slope angle δ that is smaller than slope angle β of shoulder area 18 of receiving borehole 3 in cylinder head 4.

The exemplary embodiments shown and described should be understood as being non-limiting. For example, example embodiments of the present invention may be applied to various configurations of fuel injectors 2 such as fuel injectors 2 for the injection into the combustion chamber of an internal combustion engine having self-ignition. All features may be combined with each other in any combination.

1-8. (canceled)

9. A fuel injector, comprising:
a valve housing including at least one downstream first shoulder area configured to rest on a second shoulder area of a receiving borehole in a cylinder head, the shoulder areas defining a bearing surface;
wherein the bearing surface is a quadric surface in three-dimensional space.

10. The fuel injector according to claim 9, wherein a first normal vector of the bearing surface has no parallel orientation with respect to a longitudinal axis of the fuel injector.

11. The fuel injector according to claim 10, wherein a second normal vector of the downstream first shoulder area of the valve housing, and a third normal vector of the second shoulder area of the receiving borehole have no parallel orientation with respect to one another.

12. The fuel injector according to claim 10, wherein the normal vector of the bearing surface forms an acute angle with the longitudinal axis of the fuel injector that is smaller than 45°.

13. The fuel injector according to claim 9, wherein a first slope angle of the downstream first shoulder area of the valve housing is smaller than a second slope angle of the second shoulder area of the receiving borehole in the cylinder head.

14. The fuel injector according to claim 9, wherein the bearing surface is a partial surface of the second shoulder area of the receiving borehole in the cylinder head, the partial surface being inclined at a slope angle with respect to the second shoulder area of the receiving borehole in the cylinder head.

15. The fuel injector according to claim 9, wherein the bearing surface is at least one of (a) spherical and (b) largely conical.

16. The fuel injector according to claim 9, wherein the shoulder area of the valve housing has a concave curvature, and the shoulder area of the receiving borehole in the cylinder head has a convex curvature.

17. A fuel injector, comprising:
a valve housing including at least one downstream first shoulder area resting on a second shoulder area of a receiving borehole in a cylinder head, the shoulder areas defining a bearing surface;
wherein the bearing surface is a quadric surface in three-dimensional space.
